(19) United States
(12) Patent Application Publication
(10) Pub. No.: US 2012/0046898 A1
(43) Pub. Date: Feb. 23, 2012

(54) SYSTEMS AND METHODS FOR PRESSURE MEASUREMENT USING OPTICAL SENSORS

(75) Inventors: SCOTT LEVINSON, Austin, TX (US); Rod Russell, Austin, TX (US); Stephan Bless, Austin, TX (US); Sikhanda Satapathy, Ellicott City, MD (US)

(73) Assignee: BOARD OF REGENTS OF THE UNIVERSITY OF TEXAS, Austin, TX (US)

(21) Appl. No.: 13/208,461

(22) Filed: Aug. 12, 2011

Related U.S. Application Data
(60) Provisional application No. 61/374,710, filed on Aug. 18, 2010.

(51) Int. Cl. G06F 19/00; G01L 11/02; G06F 15/00

(52) U.S. Cl. 702/98; 702/138

(57) ABSTRACT

Embodiments of systems and methods for pressure measurement using optical sensors are disclosed that include a computer processor that executes logic instructions to receive data based on optical signals from an optical sensor. The data represents velocity of the object after being exposed to a first pressure force. The velocity is determined from an unshifted, reference optical signal and a Doppler-shifted optical signal reflected off the object. The pressure force applied to the object is determined based on the velocity of the object.

### BACKGROUND

In the late 1950s and 1960s, with the advent of the aerospace era and advanced weapons development, came the requirement for high-frequency pressure sensors to make shock wave, blast, rocket combustion instability, and ballistic measurements. Products developed for this area consist of piezo-electric gauges made of materials such as quartz, tourmaline or polarized ferroelectric ceramics whose electrical resistance changes when the material is subjected to a force.

Current dynamic pressure gauges are prone to inaccuracies due to interference from RF waves and external electric or magnetic fields. Such methods are also costly and rely on electro-dynamic (piezoelectric or peizoresistive) material response, which limits detection to one plane.

### BRIEF DESCRIPTION OF THE FIGURES

Embodiments of the present invention may be better understood, and their numerous objects, features, and advantages made apparent to those skilled in the art by referencing the accompanying drawings. The use of the same reference symbols in different drawings indicates similar or identical items.

FIG. 1 shows a diagram of an embodiment of an optical pressure sensor system.

FIG. 2 shows a diagram of an embodiment of optical sensor referred to as a Photonic Doppler Velocimeter (PDV) that can be used in the sensor system of FIG. 1.

FIG. 3 shows a diagram of an embodiment of a housing and an object used as components in the sensor system of FIG. 1.

FIG. 4 shows a flow diagram of a method for determining the pressure applied to an object using an optical sensor.

FIG. 5A shows a side view of an embodiment of a test system that can be used to generate calibration data for optical sensor system of FIG. 1.

FIG. 5B shows a front view of an embodiment of a gauge mount that can be used in the test system of FIG. 5A.

FIG. 6 shows an embodiment of a computer system that can be used in the optical pressure sensor system of FIG. 1.

### DETAILED DESCRIPTION

Embodiments of pressure gauges disclosed herein use optical technology such as Photonic Doppler Velocimetry (PDV) to offer improvements in temporal and spatial resolution over existing electrodynamic pressure gauges. PDV is a particularly attractive diagnostic for experiments involving significant quantities of radiated electromagnetic energy or high-explosives because the PDV components exposed in the experimental environment are immune to electromagnetic interference. Additionally, PDV requires no direct mechanical contact with the measurement surface, and does not require electrical connections on or near the measured surface. Optical pressure gauges are significantly less expensive than existing electrodynamic pressure gauges and can therefore be considered expendable in certain experiments. Possible applications include, among others, measurements of ground shock and air shock from explosions, evaluating shock waves for deflagration/detonation assessment, and understanding and controlling the combustion process in gas turbine engines to achieve increased efficiency, reduced emissions, and lower operating costs.

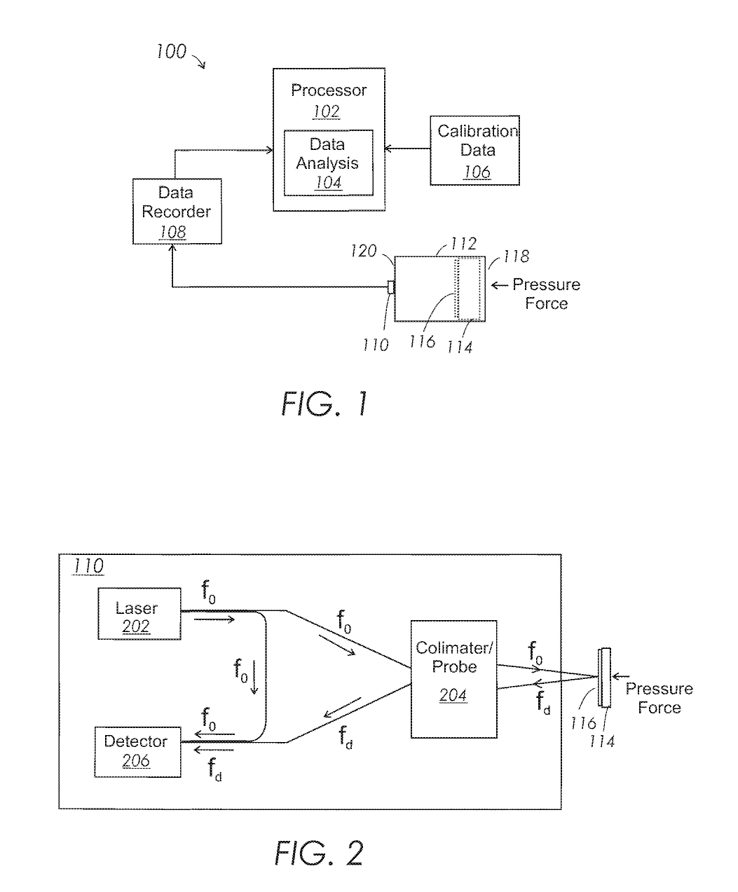

FIG. 1 shows a diagram of an embodiment of an optical pressure sensor system 100 including processor 102, data analysis module 104, calibration data 106, data recorder 108, optical sensor 110, housing 112, and object 114 movable within housing 112. Object 114 typically includes a retro-reflective surface 116 that faces optical sensor 110 and reflects the optical signals back toward the optical sensor.

Housing 112 includes an opening to expose a surface of object 114 to the ambient environment at one end 118. An opposite end 120 of housing 112 where optical sensor 110 can be positioned can be open, partially sealed, or completely sealed.

Object 114 is configured to move in an inner portion of housing 112 when a pressure force is applied to object 114. Object 114 can be initially positioned in housing 112 at or near the opening at end 118 and moves toward optical sensor 110 at the opposite end 120 of housing 112 when a pressure force in the ambient environment is applied to the exposed surface of object 114. Housing 112 and object 114 can be dimensioned to allow object 114 to move without reaching end 120 of the housing before the pressure force acting on object 114 has stopped.

In some embodiments, housing 112 is a hollow cylinder and object 114 is a piston positioned in cylindrical housing. 112. One end of housing 112 is at least partially open to the pressure force and the piston is configured to move in housing 112 when the pressure force is applied to the piston. In further embodiments, housing 112 is configured to provide an air cushion around object 114 to reduce friction between the housing and the object. Other mechanisms for reducing friction between housing 112 and object 114 can be used. Reducing or eliminating friction between the surfaces of housing 112 and object 114 improves consistency in performance of different pressure sensors 110 during measurement. Additionally, consistent performance of sensors 110 allows the same calibration data 106 to be used for pressure sensors 110 that are configured with similar housings 112, objects 114, and optical sensors 110.

In some embodiments, housing 112 is cylindrical, and object 114 is a cylindrical piston positioned in the cylindrical housing. Other suitable shapes for housing 112 and object 114 can used. For example, object 114 can be an elastic membrane positioned over an opening of housing 112 that deflects inwardly in the housing when the membrane is subject to a pressure force. Optical sensor 110 can be configured to measure the velocity of deflection instead of translational movement of object 114. The deflection of the membrane and return to initial position can be taken into account in determining the pressure force.

Although gravity may cause object 114 to rest on the inner surface of housing 112, the resulting friction will be insignificant compared to the pressure accelerating forces in transient, high-pressure applications. In low-pressure applications, low friction, low mass piston materials can be used to minimize the fiction between housing 112 and object 114.

In some embodiments, sliding friction will be eliminated completely by using flexible membrane material rather than a sliding piston/cylinder. In such embodiments, the position and velocity of the flexing material will be carefully calibrated to pressure.

Optical sensor 110 is positioned to emit an optical signal on object 114. In some configurations, optical sensor 110 is configured at one end of housing 112 to emit the optical signals toward object 114. Components of optical sensor 110 can be configured in other suitable location(s) in system 100 to emit and detect optical signals to and from object 114 when object 114 is stationary and in motion.

FIG. 2 shows a diagram of an embodiment of optical sensor 110 referred to as a Photonic Doppler Velocimeter (PDV) that can be used in system 100. (Note FIG. 2 is based on a diagram of a PDV in FIG. 1 in O.T. Strand et al. Compact system for high-speed velocimetry using heterodyne techniques, Review of Scientific Instruments 77, 083108 (2006)). Optical sensor 110 includes laser 202 that emits optical signals f₀) through a fiber optic material to collimator/probe 204. Probe 204 emits laser light signal f₀ on a reflective surface 116 of object 114. When object 114 is moving, the reflective light is Doppler-shifted, as indicated by symbol f_{d}. Probe 204 collects Doppler-shifted light signals f_{d} reflected from object 114 and sends the light signals f_{d} to detector 206. Detector 206 also received optical signals f₀ from laser 202 via a fiber optic material.

PDV is a Doppler-heterodyne procedure that measures the beat frequency between an unshifted, near-infrared reference light wave that propagates at wavelength λ₀ (or frequency f₀=c/λ₀, where c is the speed of light) and the Doppler-shifted light reflected off a moving surface. Mixing the unshifted reference laser signal at frequency f₀ with the Doppler-shifted reflected signal at instantaneous frequency f₁ produces a beat frequency

f(t)=|f₀−f₁|=2v(t)/λ₀,

where v(t) is the time-varying speed of object 114. A detector converts the optical signal to an electrical signal (voltage) that is proportional to the instantaneous beat frequency. The detected signal power is proportional to the time-averaged output intensity

I(t)≅I₀+I₁+2·\sqrt{I₀·I₁} cos(2π·f(t))·t+φ,

where I₀ and I₁ are the transmitted and received laser signal intensities, respectively, and φ is a phase constant. Short-time Fourier transforms can be used to calculate the spectral content of the instantaneous frequency and instantaneous velocity, since both are effectively constant over the small time interval needed to measure velocities.

In some embodiments, a four-channel PDV system designed by David Holtkamp et al. of Los Alamos National Laboratory (LANL) of Los Alamos, N. Mex. and constructed by National Security Technologies of Las Vegas, Nev. can be used as optical sensor 110. The PDV system can be excited with an IPG Photonics ELR-Series, narrow-band (<30 kHz), single-mode laser (λ=1549.44 nm) at a power level of 1.6 W (0.4 W/PDV-channel). The high-resolution PDV signals are digitally recorded at constant digital sample rate, for example, of fₛ=1/Δt=6.25 GHz. Other suitable sample rates can be used.

PDVs were developed as an alternative velocimetry diagnostic technique to the velocity interferometer system for any reflector (VISAR) and Fabry-Pérot [4] interferometers for short-range, high-velocity shock experiments. The PDV uses a heterodyne method that has many of the advantages of the VISAR and other optical systems while avoiding many of their disadvantages. The PDV is compact, relatively inexpensive, and can be assembled fairly easily from commercially available parts. (See, for example, O.T. Strand, et. al, Compact System For High-Speed Velocimetry Using Heterodyne Techniques, Review Of Scientific Instruments 77, 083208 (2006)). The derived velocity time history is directly related to the frequency of the beat wave form, so there is no need for extra components in the system to resolve velocity ambiguities. The data are recorded on digital data recorder 108, which can provide recording lengths sufficient to capture the amount of data required to determine the pressure profile. Data analyses with Fourier transform techniques allow the heterodyne method to observe multiple discrete velocities and even velocity dispersion. The PDV is robust against high-intensity fluctuations of light reflected from object 114 moving at high-speed. The PDV system does not suffer from data ambiguity due to short-time signal loss, since the velocity information is encoded in the frequency of the recorded signal. This is in contrast with a VISAR, where continuous measurement of the phase is required for a true velocity record.

Referring again to FIG. 1, data recorder 108 typically receives data signals from optical sensor 110 and provides digitized data signals to computer processor 102. An example of a data recorder 108 that can be used in system 100 is a digitizer/oscilloscope, model number (TDS6804B) commercially available from Tektronix Corporation of Beaverton, Oreg. (USA). Other suitable data recording devices can be used, however.

Computer processor 102 can include components and execute logic instructions including data analysis module 104 to receive data from recorder 108 based on optical signals from optical sensor 110. The optical signals include signals that are reflected off object 114 and the data represents velocity of object 114 after object 114 is exposed to a pressure force. Analysis module 104 can further determine the velocity of object 114 from the data 114 and determine the pressure force applied to object 114 based on the velocity of object 114.

As an example of functions performed by analysis module 104, the frequency and velocity spectral content of the signal can be obtained by short-time Fourier transforms of the digitized beat signal. The signal frequency is directly proportional to the projectile velocity

$$v = 0.775 \frac{km \text{/} s}{GHz} \cdot f .$$

The signal frequency can be treated as a constant in the small time-subinterval nΔt, over which each of a series of fast Fourier transforms (FFTs) are calculated. A user-selectable integer n determines the frequency (or velocity) interval size: Δf=1/(nΔt). The sample rate fₛ is typically several times the highest frequency component (at least twice to avoid aliasing), which is proportional to the highest projectile velocity during a launch.

Temporal and velocity resolution can be adjusted during data processing after the measurements are taken. As n increases, so does the frequency resolution—with smaller and more (=n/2) frequent (velocity) components obtained. The direct tradeoff is decreased time resolution, where an increased time subinterval nΔt corresponds to fewer and sparser time measurements. A series of 50% overlapping, Hamming windowed, short-time Fourier transforms x(v)=ℑ(I(v(t)) of the digitized PDV signal records can be used to calculate the spectral content of the instantaneous velocity v. The spectral content can be calculated and displayed in decibels as a two-dimensional spectrogram

S(vᵢ,Tₖ)=10 log 10[|x(vᵢ,Tₖ|²],

where x(vᵢ, Tₖ) is the fast Fourier transform of the k^{th} subrecord of the beat signal intensity I(Δfᵢ, Tₖ) centered about time Tₖ and velocity vᵢ.

$${v}_{i} = ( 0.7746115 \frac{m \text{/} s}{MHz} ) \cdot {f}_{1} .$$

Once a velocity profile of object 114 is calculated over the time period when the pressure force is applied, analysis module 104 can access and use calibration data 102 that maps different velocities to corresponding pressure forces to determine the pressure force applied to the object 114. Calibration data 106 can be derived from pressure measurements taken with electrodynamic pressure sensors or other suitable pressure sensors in the vicinity of housing 112. With regard to housing 112, when end 120 of housing 112 is closed, backpressure can build up between object 114 and end 120 as object 114 moves toward end 120. The backpressure force typically prevents object 114 from moving as far or as quickly through housing 112 as object 114 would move if end 120 were open or at least partially open to relieve the backpressure. When end 120 is closed, an isentropic correction can be applied to account for the backpressure in determining the pressure force acting on object 114 at open end 118.

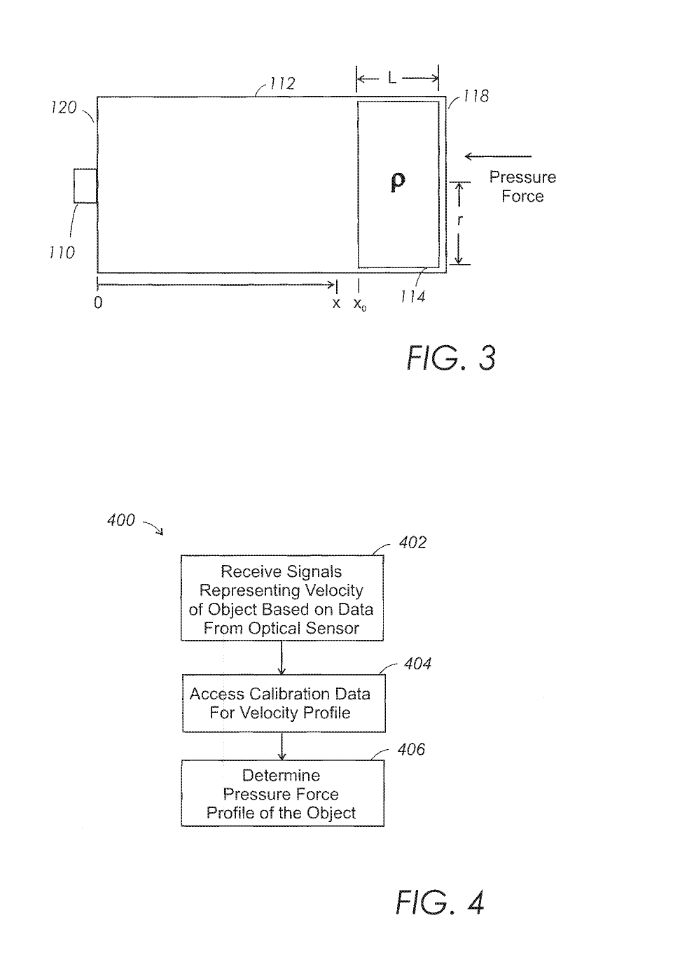

Referring to FIG. 3, a diagram of an embodiment of housing 112 and object 114 used as components in the sensor system 100 of FIG. 1 are shown. Housing 112 can have a sealed, an unsealed, or partially sealed end 120, and the pressure profile may be determined using the derivative of the velocity over time

P(t)=ρL(dv/dt) Equation (1)

where ρ is the mass density of object 114, L is the axial length of object 114, and dv/dt is the piston acceleration over time based on the velocity profile determined from the optical data from optical sensor 110.

The pressure profile when end 120 of housing 112 is sealed can be determined using the Equation (1) above with an isentropic correction to account for the backpressure:

Pi=ρL(dv/dt)/(1−(x₀/x(t))^{γ}) Equation (2)

where γ is the specific heat ratio of air and is equal to 1.4 at standard day conditions, x₀ is the initial position of object 114 in housing 112, and x is the position of object 114 in housing 112 after the pressure force has acted on object 114.

Optical pressure gauge system 100 can use a variety of different optical sensors 110 in addition to or instead of a PDV as long as the optical sensor 110 is capable of providing Doppler-shifted frequency data at intervals that are sufficient for determining the velocity and acceleration of object 114 over the time period that pressure is applied to object 114.

In another embodiment, sensor system 100 includes housing 112, a first opening in one end 118 of housing 112 and object 114 positioned in an inner portion of housing 112. The opening in end 118 allows object 114 to be exposed to a pressure force. Object 114 is configured to move in the inner portion of housing 112 when the pressure force is applied to object 114. Optical sensor 110 is positioned to emit optical signals on object 114 and to detect reflected optical signals from object 114. The velocity of object 114 and the pressure force exerted on object 114 are determined from frequency changes between the optical signals and the reflected optical signals. The frequency changes in the optical signals are proportional to changes in corresponding surface velocities of object 114. The optical frequency measurements are insensitive to radiofrequency waves, as well as external electric or magnetic fields.

Referring to FIG. 4, a flow diagram of a method 400 for determining the pressure applied to an object using an optical sensor is shown. Method 400 may be implemented a logic instructions executable by a computer processor. Process 402 receives data based on the optical signals and the reflected optical signals. The data may be provided by a digitizer that converts analog optical signals to digital electrical signals. The data represents the velocity of the object after being exposed to a first pressure force.

Process 404 can include accessing calibration data to determine the velocity of the object from the data received in process 402. The calibration data can be implemented in data tables, as an equation, or other suitable format for deriving velocity from the data from the optical sensor. The calibration data will typically be the same for systems using the same dimensions and types of physical components. Note that systems with different dimensions and types of physical components will require a set of calibration data that was generated for the particular configuration.

Process 406 includes determining the first pressure force applied to the object based on the velocity of the object, as further described in the discussion of FIG. 3 herein.

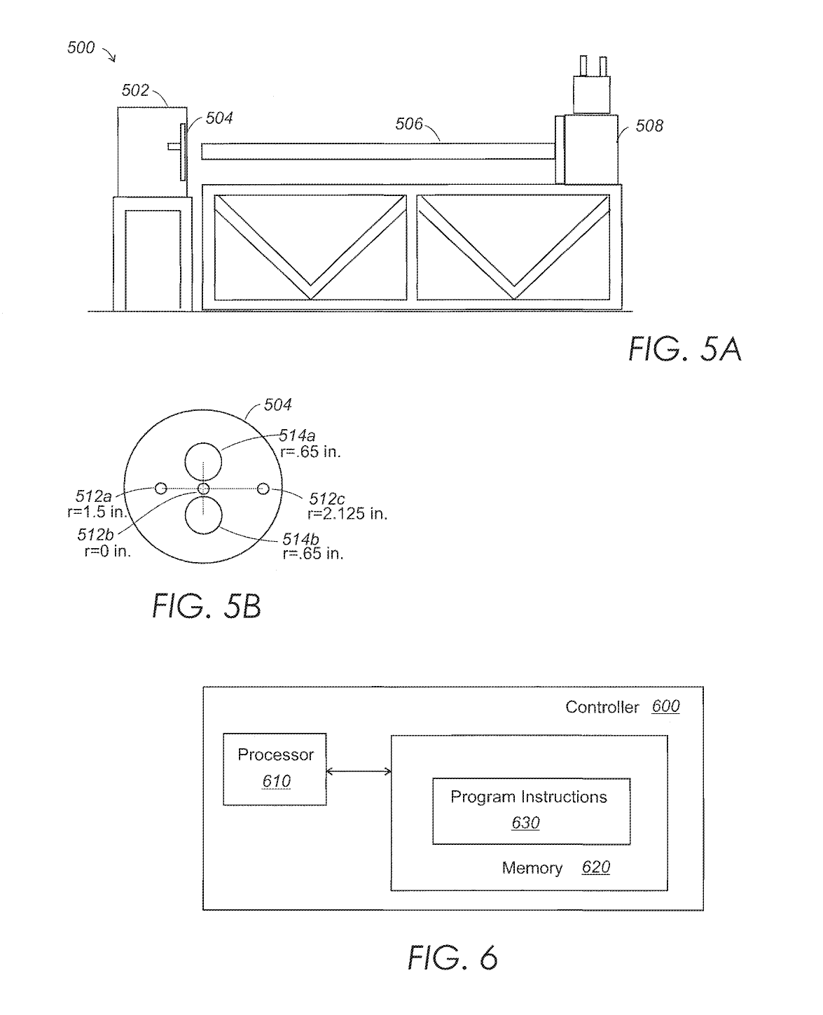

Once a velocity profile of object 114 is calculated over the time period when the pressure force is applied, analysis module 104 can access and use calibration data 106 that maps different velocities to corresponding pressure forces to determine the pressure force applied to the object 114. Calibration data 106 can be derived from pressure measurements taken with electrodynamic pressure sensors or other suitable pressure sensors in the vicinity of housing 112. For example, FIG. 5A shows a side view of an embodiment of a test system 500 that can be used to generate calibration data for optical sensor system 100. In the embodiment shown, test system 500 includes mounting structure 502 for gauge mount 504, gun barrel 506, and gas gun 508. Gas gun 508 generates pressure pulses by firing a burst of air (without a projectile) down gun barrel 506 toward gauge mount 504.

FIG. 5B shows a front view of an embodiment of gauge mount 504 including three piezoelectric sensors 512a, 512b, 512c (collectively, “512”) and two PDV sensors 514a, 514b (collectively, “514”). Piezoelectric sensors 512 can be positioned at varying distances from the center of gauge mount 504. In the embodiment shown, pressure forces from gas gun 508 are measured by calibrated piezoelectric sensors 512 at offset radii of 2.125 inches, 0.0 inches, and 1.5 inches from center of gauge mount 504. The pressure force is also measured by uncalibrated piezoelectric sensors 512 at offset radii of 0.65 inches from center of gauge mount 504. The pressure signals from the calibrated piezoelectric sensors 512 are compared to pressure signals derived from PDV sensors 514 to generate calibration data 106 for PDV sensors 514.

Note that although gauge mount 504 is shown with three piezoelectric sensors 512 and two PDV sensors 514 in a specific configuration, additional or fewer numbers of sensors can be used in different configurations. Further, calibration data 106 generated for specific types and arrangements of optical sensor systems 100 can be used for all systems 100 having the same characteristics.

Referring to FIGS. 1, 4, and 6, FIG. 6 illustrates a block diagram of a computer system 600, according to some embodiments that can be used to implement processor 102, data analysis module 104, and method 400. The computer system 600 includes a processor 610 coupled to a memory 620. The memory 620 can be operable to store program instructions 630 such as analysis module 104 that are executable by the processor 610 to perform one or more functions. It should be understood that the term “computer system” can be intended to encompass any device having a processor that can be capable of executing program instructions from a memory medium. In a particular embodiment, the various functions, processes, methods, and operations described herein may be implemented using the computer system 600. For example, controller 102 or any components thereof, may be implemented using the computer system 600.

The various functions, processes, methods, and operations performed or executed by the system 600 can be implemented as the program instructions 630 (also referred to as software or computer programs) that are executable by the processor 610 and various types of computer processors, controllers, central processing units, microprocessors, digital signal processors, state machines, programmable logic arrays, and the like. In an exemplary, non-depicted embodiment, the computer system 600 may be networked (using wired or wireless networks) with other computer systems.

In various embodiments the program instructions 630 may be implemented in various ways, including procedure-based techniques, component-based techniques, object-oriented techniques, rule-based techniques, among others. The program instructions 630 can be stored on the memory 620 or any computer-readable medium for use by or in connection with any computer-related system or method. A computer-readable medium can be an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type. A computer-readable medium can be any structure, device, component, product, or other means that can store, communicate, propagate, or transport the program for use by or in connection with the instruction execution system, apparatus, or device.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the processes necessary to provide the structures and methods disclosed herein. Variations and modifications of the embodiments disclosed herein may also be made while remaining within the scope of the following claims. The functionality and combinations of functionality of the individual modules can be any appropriate functionality. Additionally, limitations set forth in publications incorporated by reference herein are not intended to limit the scope of the claims. In the claims, unless otherwise indicated the article “a” is to refer to “one or more than one”.

We claim:

1. A pressure gauge system comprising:
a computer processor including logic instructions operable to:
receive data based on optical signals from an optical sensor, the data represents velocity of the object after being exposed to a first pressure force, the velocity is determined from an unshifted, reference optical signal and a Doppler-shifted optical signal reflected off the object;
determine the velocity of the object from the data; and
determine the first pressure force applied to the object based on the velocity of the object.

2. The system of claim 1, further comprising:
a housing, a first opening in one end of the housing, the opening exposes a portion of the object to the first pressure force; and
the object, wherein the object is configured to move in an inner portion of the housing when the pressure force is applied to the object.

3. The system of claim 2, further comprising:
the optical sensor positioned to emit an optical signal on the object.

4. The system of claim 2, further comprising:
the optical sensor includes:
a laser operable to emit optical signals; and
a detector that detects the optical signals reflected off the object and the optical signals from the laser.

5. The system of claim 1, further comprising:
the object includes a reflective surface that reflects the optical signals back toward the optical sensor.

6. The system of claim 1, further comprising:
calibration data that maps different velocities to corresponding pressure forces; and
logic instructions that access and use the calibration data to determine the first pressure force applied to the object.

7. The system of claim 2, further comprising:
the optical sensor is configured at one end of the housing to emit the optical signals toward the object.

8. The system of claim 1, further comprising:
the optical sensor is a Photonic Doppler Velocimeter (PDV).

9. The system of claim 1, further comprising:
a digital data recorder configured to receive the data signals from the optical sensor. and provide the data signals to the computer processor.

10. The system of claim 1, further comprising:
a cylindrical housing;
the object is a piston positioned in the cylindrical housing, one end of the housing is at least partially open to the first pressure force; and
the piston is configured to move in the housing when the first pressure force is applied to the piston.

11. The system of claim 1, further comprising:
a housing, a first opening in one end of the housing, the opening exposes an inner portion of the housing to the first pressure force; and
the object, wherein the object is configured to move in the inner portion of the housing when the first pressure force is applied to the object.

12. The system of claim 2, further comprising:
the housing is configured to provide an air cushion around the object to reduce friction between the housing and the object.

13. The system of claim 2, further comprising:
the housing includes a closed end opposite the end of the housing with the opening; and
an isentropic correction is applied to determine the first pressure force to account for a second pressure force that acts on the object opposite the first pressure force due to the closed end.

14. The system of claim 6, further comprising:
the calibration data is derived from pressure measurements taken with electrodynamic pressure sensors in the vicinity of the housing.

15. A pressure gauge system comprising:
a housing, a first opening in one end of the housing;
an object, wherein
the first opening exposes the object to a first pressure force, and
the object is configured to move in an inner portion of the housing when the first pressure force is applied to the object; and
an optical sensor positioned to emit optical signals on the object and to detect reflected optical signals from the object, the velocity of the object and the first pressure force are determined from Doppler-shifted frequency changes between the optical signals and the reflected optical signals.

16. The system of claim 15, further comprising:
a computer processor including logic instructions operable to:
receive data based on the optical signals and the reflected optical signals, the data represents the velocity of the object after being exposed to a first pressure force;
determine the velocity of the object from the data; and
determine the first pressure force applied to the object based on the velocity of the object.

17. The system of claim 15, further comprising:
the optical sensor includes:
a laser operable to emit the optical signals; and
a detector that detects the reflected optical signals.

18. The system of claim 15, further comprising:
the object includes a reflective surface that reflects the optical signals back toward the optical sensor.

19. The system of claim 16, further comprising:
calibration data that maps different velocities to corresponding pressure forces; and
logic instructions that access and use the calibration data to determine the first pressure force applied to the object.

20. The system of claim 15, further comprising:
the optical sensor is configured at another end of the housing opposite the opening to emit the optical signals toward the object.

21. The system of claim 15, further comprising:
the optical sensor is a Photonic Doppler Velocimeter (PDV).

22. The system of claim 15, further comprising:
a digital data recorder configured to receive the data signals from the optical sensor and provide the data signals to the computer processor.

23. The system of claim 15, further comprising:
the housing and the object are dimensioned to allow the object to move without reaching another end of the housing before the first pressure force acting on the object has stopped.

24. The system of claim 15, further comprising:
the housing is cylindrical; and
the object is a piston positioned in the cylindrical housing.

25. The system of claim 15, further comprising:
the housing is configured to provide an air cushion around the object to reduce friction between the housing and the object.

26. The system of claim 15, further comprising:
the housing includes a closed end opposite the end of the housing with the opening; and
an isentropic correction is applied to determine the first pressure force to account for a second pressure force that acts on the object opposite the first pressure force due to the closed end.

27. The system of claim 19, further comprising:
the calibration data is derived from pressure measurements taken with electrodynamic pressure sensors in the vicinity of the housing.

28. A method for determining pressure force acting on an object comprising:
receiving optical signals reflected from an object;
determining a velocity profile of the object based on a Doppler frequency shift between the optical signals reflected from the object and reference optical signals; and
determining a pressure force profile acting on the object based on the velocity profile.

29. The method of claim 10, further comprising:
generating calibration data for determining the pressure force profile based on measurements from electrodynamic pressure sensors.
